(19) United States
(12) Patent Application Publication
(10) Pub. No.: US 2013/0146236 A1
(43) Pub. Date: Jun. 13, 2013

(54) VENETIAN BLIND SLAT

(71) Applicant: Chin-Fu CHEN, Taichung City (TW)

(72) Inventor: Chin-Fu CHEN, Taichung City (TW)

(21) Appl. No.: 13/411,868

(22) Filed: Mar. 5, 2012

(30) Foreign Application Priority Data
Dec. 12, 2011 (TW) 100145817

(51) Int. Cl. E06B 9/386

(52) U.S. Cl. 160/236

(57) ABSTRACT

A Venetian blind slat includes a leather substrate and two rods. The leather substrate has an upper strip and a lower strip sewed to the upper strip to define two elongated spaces between the upper and lower strips along two long sides of the leather substrate. Each of the rods is inserted into and held within one of the elongated spaces of the leather substrate. The Venetian blind is lightweight and has good thermostability and flexibility.

### BACKGROUND OF THE INVENTION

1. Field of the Invention

The present invention relates generally to a Venetian blind slat, and more specifically to a Venetian blind slat having a dramatic visual effect in its appearance.

2. Description of the Related Art

To prevent the sunshine from streaming into a house, curtains made of fabric or Venetian blinds composed of slats are usually mounted to the windows of the house. Conventionally, the slats of the Venetian blinds are mostly made of aluminum alloy or other metals for making the window blinds lightweight and fireproof

Since the slats made of aluminum look monotonous in appearance, manufactures may sometimes decorate the surfaces of the slats with wood grains or stone grains for enhancement of visual effect of the blind slats. However, the metallic slats will expand as the temperature increases and contract when they are cooled, and therefore these patterns may be gradually peeled off due to the deformation of the metallic slats, thereby deteriorating the visual aestheticism of the slats.

### SUMMARY OF THE INVENTION

It is one objective of the present invention to provide a Venetian blind slat, which has a less thermal expansion in response to a change of temperature to have a good thermostability.

To achieve this objective of the present invention, the Venetian blind slat provided by the present invention comprises an elongated leather substrate and two rods. The leather substrate includes an upper strip and a lower strip sewed to the upper strip to form two elongated spaces between the upper and lower strips along two long sides of the leather substrate for insertion of the rod. The two rods are inserted into the two elongated spaces of the elongated leather substrate respectively.

Preferably, the rods may be made of fiber reinforced resin and may have circular shape or other geometrical shapes in its cross section, such that the Venetian blind slat of the present invention has advantages of lightweight, good structural strength, easy manufacturing, and good corrosion resistance, thermostability and flexibility.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a Venetian blind slat according to a preferred embodiment of the prevent invention; and

FIG. 2 is a sectional view of the Venetian blind slat according to the preferred embodiment of the prevent invention.

### DETAILED DESCRIPTION OF THE INVENTION

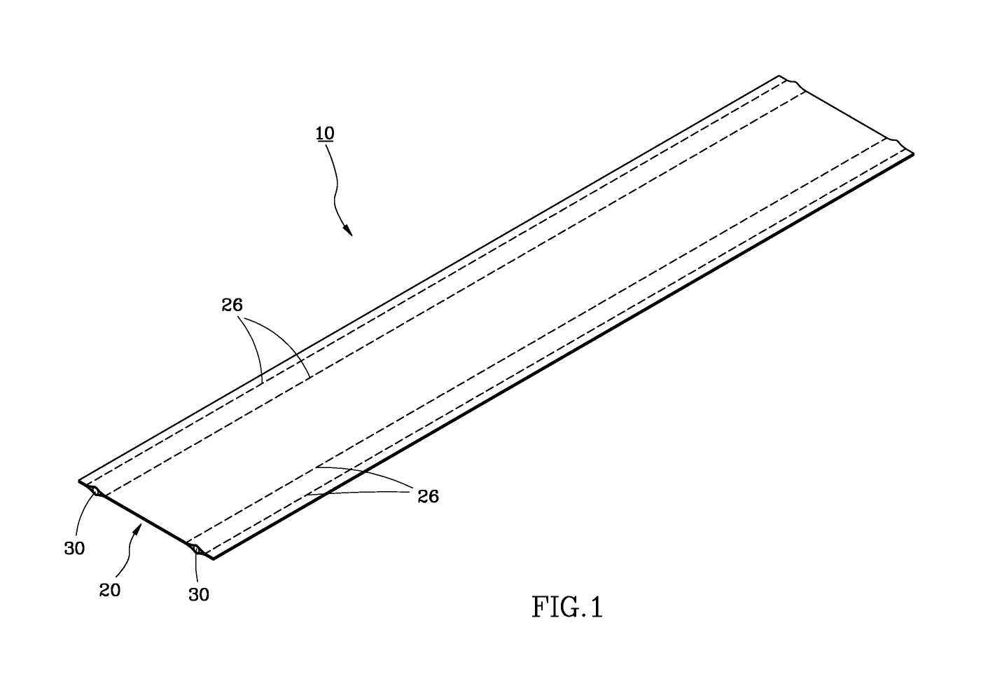

As shown in FIG. 1, a Venetian blind slat 10 in accordance with a preferred embodiment of the present invention comprises an elongated leather substrate 20 and two rods 30.

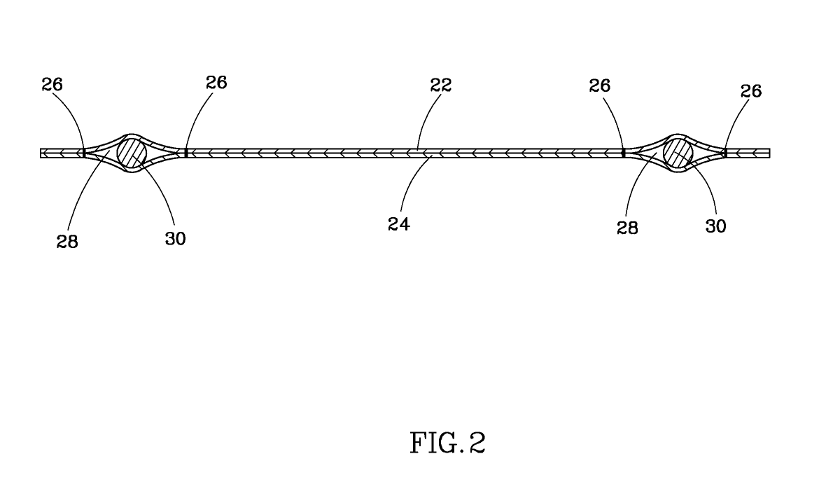

The leather substrate 20 can be made of, but not limited to, a genuine leather or artificial leather. As shown in FIG. 2, the leather substrate 20 has an upper strip 22 and a lower strip 24. The upper strip 22 is sewed to the lower strip 24 in such a manner that two long sides of the upper strip 22 and two long sides of the lower strip 24 are respectively sewed to each other to form two pairs of parallel seams 26 along two long sides of the leather substrate 20 and two elongated spaces 28, each of which is defined between the upper and lower strips 22 and 24 and between a pair of the parallel seams 26.

Each of the rods 30 is circular in cross-section and inserted into one of the elongated spaces 28 of the leather substrate 20. The rods 30 are made of fiber reinforced resin. The fiber used in the aforesaid fiber reinforced resin can be, but not limited to, carbon fiber, glass fiber, boron fiber or Kevlar fiber. For the resin, thermosetting resin or thermoplastic resin can be used. Besides, the rods 30 may have a rectangular shape or other geometrical shapes in cross section.

By means of the aforesaid design and the use of the leather as the main material of the Venetian blind slat 10 of the present invention, the Venetian blind slat 10 won't extensively expand or contract, i.e. won't deform easily, under the room temperature variation and the Venetian blind slat 10 can have a good flexibility. This will help the Venetian blind slat 10 of the present invention to provide a dramatic visual effect in its appearance. In addition, if any pattern is coated on the surface of the leather substrate 20, the pattern won't be easily peeled off due to the good thermostability and flexibility of the Venetian blind slat 10. Further, because of the rods 30 made of fiber reinforced resin and used as a main structural support of the Venetian blind slat 10, the Venetian blind slat 10 of the present invention has the advantages of lightweight, high structural strength, easy manufacturing, superior corrosion resistance, high thermostability, and good flexibility.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A Venetian blind slat comprising:
an elongated leather substrate having an upper strip and a lower strip sewed to the upper strip in a way that two elongated spaces are defined between the upper strip and the lower strips along two long sides of the elongated leather substrate; and
two rods inserted into the two elongated spaces of the elongated leather substrate respectively.

2. The Venetian blind slat as claimed in claim 1, wherein the upper strip and the lower strip are sewed together to form two pairs of parallel seams along the two long sides of the elongated leather substrate; each of the elongated spaces is defined between one pair of the parallel seams.

3. The Venetian blind slat as claimed in claim 1, wherein each of the rods is made of fiber reinforced resin.

4. The Venetian blind slat as claimed in claim 1, wherein each of the rods has a circular cross-section.
